(19) United States
(12) Patent Application Publication
(10) Pub. No.: US 2017/0314272 A1
(43) Pub. Date: Nov. 2, 2017

(54) Removable Downspout Cover Device

(71) Applicant: Mark Phillips, New Britain, CT (US)

(72) Inventor: Mark Phillips, New Britain, CT (US)

(21) Appl. No.: 15/143,781

(22) Filed: May 2, 2016

(51) Int. Cl. E04D 13/08; G09F 7/18; A63B 63/08

(52) U.S. Cl. CPC E04D 13/08; A63B 63/083; G09F 7/18

(57) ABSTRACT

A cover device comprised of material of varying lengths sized to extend partway around and partway along an object such as but not limited to a downspout with fasteners extending along the lateral edges to attach material to object.

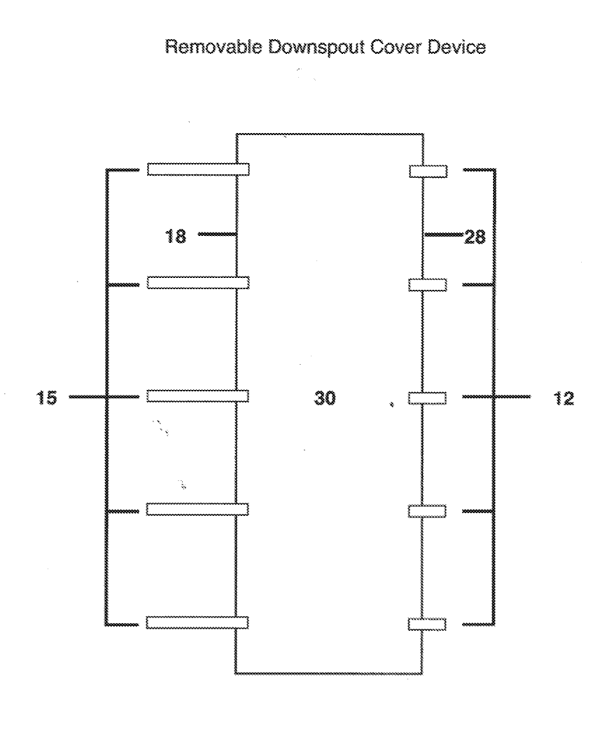

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The use of materials to decorate or show support teams or countries by attaching it outside of a dwelling or building. For example flags of sporting teams, flags of countries and seasonal products flown in some manner.

Based on the foregoing, it is the general object of the present invention to offer ways to utilize the device on downspouts on a dwelling or building for their enjoyment or enthusiasm.

### BRIEF SUMMARY OF THE INVENTION

This invention relates generally to a device to cover or partially cover a downspout.

### BRIEF DESCRIPTION OF THE SEVERAL VIEWS OF THE DRAWING

The drawing depicts the outside of the preferred embodiment of the invention.

### DETAILED DESCRIPTION OF THE INVENTION

The REMOVABLE DOWNSPOUT COVER DEVICE wraps around an object, such as but not limited to a downspout, and affixes.

In the preferred embodiment shown in the drawing, hook and loop fasteners are used to affix or fasten the REMOVABLE DOWNSPOUT COVER DEVICE. At least one strip of hook fastener and at least one strip of loop fastener are required.

To manufacture one REMOVABLE DOWNSPOUT COVER DEVICE, at least one layer of planar sheet of material comprising a blend such as but not limited to thirty percent cotton and seventy percent polyester, 30, is cut into approximately a rectangle shape so that the rectangle is longer than it is wide.

At least one strip of hook fastener is affixed flat such as but not limited to being sewn along an edge, 18, of the REMOVABLE DOWNSPOUT COVER DEVICE so that the hook fasteners are exposed such as reference number 15.

On the opposed or opposite side of the REMOVABLE DOWNSPOUT COVER DEVICE as in the drawing, at least one strip of loop fastener, 12, is affixed flat such as but not limited to being sewn near the edge of the material, 28, which is opposite to the edge to which the hook fastener, 15, was previously affixed.

Each strip of loop fastener is affixed so that the loop fasteners are exposed.

Each strip of hook fastener is affixed so that the hook fasteners are exposed.

Each strip of loop fastener is affixed parallel to the other strips of loop fasteners.

Each strip of hook fastener is affixed parallel to the other strips of hook fasteners.

Each strip of hook and loop fastener is affixed so that one of the sides of the strip is approximately three quarters of an inch from the edge of the material to which it is affixed.

The hook and loop fasteners are affixed to the material so that when the REMOVABLE DOWNSPOUT COVER DEVICE is wrapped around an object such as but limited to a downspout the fasteners affix to each other.

The REMOVABLE DOWNSPOUT COVER DEVICE, 30 defines opposing sides 18 and 28, adjacent to which are attached fasteners 15 and 12 for joining these sides together when the device is wrapped around an object such as but not limited to a downspout. In the illustrated embodiment, these fasteners 15 and 12 are in the form of hook and loop fastening material with a plurality of strips (five shown) of hooked material extending along one of the said opposed edges 18, and a plurality of strips (five shown) 12 of looped fastening material being attached adjacent to the other of the opposing ends 28 approximately parallel to the strips of hooked material. However, the present invention is not limited in this regard as the hooked and looped strips of material 15, 12 can be substituted for one another without departing from the broader aspects of the present invention. Moreover, while hook and loop fasteners are shown and described, the present invention is not limited in this regard as other types of fasteners, such as, but not limited to, buttons or snaps, hooks, laces, strings, elastic, zippers, or adhesives can be employed without departing from the broader aspects of the present invention.

While the present invention has been shown and described as being fabricated from a blend comprising cotton and polyester material, the invention is not limited in this regard as other textile or non-textile material, such as leather, or other blends of materials could be and are anticipated to be substituted without departing from the broader aspects of the present invention.

While preferred embodiments have been shown and described, various modifications and substitutions may be made without departing from the spirit and scope of the invention.

Additionally, in the preferred embodiment shown, it is contemplated that the REMOVABLE DOWNSPOUT COVER DEVICE may comprise shaped devices comprised of materials such as, but not limited to, plastic, wood, or leather.

Accordingly, it is to be understood that the present invention has been described by way of example, and not by limitation.

It is to be understood that the present invention contemplates that the number, size, position, affixing, and, orientation of the strips of hooked and looped fastening material can vary from that of the preferred embodiment. Furthermore, any other number, size, position, affixing, and orientation of fastening means can be utilized such as, but not limited to, hook and loop, laces, straps, bindings, buttons, hooks, snaps, laces, strings, elastic and zippers.

It is to be understood that the present invention is comprised of one or more materials. It is to be understood that the present invention contemplates components or processes to provide uses such as but not limited to warmth, protection, decoration and repair. The types of material, the number of layers of planar sheets of material, the shape of the material, the composition of materials, the thickness of the material, liners, the number of liners, liners comprising electrical components, and method of affixing material, may vary and does not limit the invention.

While preferred embodiments have been shown and described, various modifications and substitutions may be made without departing from the spirit and scope of the invention. Accordingly, it is to be understood that the present invention has been described by way of example, and not by limitation.

What is claimed is:

1. A device comprising: at least one layer of planar sheet of material defining opposed edge portions which is sized to extend at least partway around an object
such as but not limited to a downspout; wherein the device comprises fastening means for joining said opposed edge portions.

2. The device of claim 1, wherein the planar sheet of material comprising the device is comprised of a blend such as but not limited to thirty percent cotton and seventy percent polyester.

3. The device of claim 1, wherein the fastening means comprising the device are comprised of hook and loop fasteners.

4. The device of claim 1, wherein the device is intended to decorate the object.

5. The device of claim 1, wherein the device is intended to repair the object.

6. The device of claim 1, wherein the device is intended to heat the object.

7. The device of claim 1, wherein the device is intended to protect the object.

8. The device of claim 1, wherein the device is intended to comprise part of a game such as but not limited to affixing a basketball net to an object.
